(19) United States
(12) Patent Application Publication
(10) Pub. No.: US 2009/0327945 A1
(43) Pub. Date: Dec. 31, 2009

(54) WORK FLOW MANAGEMENT APPARATUS AND WORK FLOW MANAGEMENT METHOD

(75) Inventor: Hajime Tomizawa, Izunokuni-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/490,623

(22) Filed: Jun. 24, 2009

Related U.S. Application Data
(60) Provisional application No. 61/076,272, filed on Jun. 27, 2008.

(51) Int. Cl. G06F 9/46; G06F 3/048

(52) U.S. Cl. 715/772; 718/102

(57) ABSTRACT

There is provided a management technique of a work flow in a case where a document as an arbitrary processing object is processed by the work flow. Information relating to document data as a processing object of the work flow is acquired, information relating to respective processing steps constituting the work flow as a management object is acquired, information relating to execution conditions for execution of the respective processing steps is acquired based on the acquired information relating to the respective processing steps, and it is determined, based on the acquired information relating to the execution conditions, whether the document data whose information is acquired can be processed by the work flow as the management object.

### CROSS-REFERENCE TO RELATED APPLICATION

This application is based upon and claims the benefit of priority from: U.S. provisional application 61/076,272, filed on Jun. 27, 2008, the entire contents of each of which is incorporated herein by reference.

### TECHNICAL FIELD

The present invention relates to a management technique of a work flow.

### BACKGROUND

Hitherto, in a system for performing a process using a work flow on digitized data obtained by scanning a document image, a technique of retrieving a work flow to perform a process desired by a user from plural kinds of work flows is proposed.

In the related art, first, document images treated in the respective work flows are stored. Then, when a process using a work flow is performed on a certain document image, a work flow which treated a document image most similar to the document image as the processing object is retrieved from a database, and the work flow is presented to the user (see, for example, JP-A-2008-46850).

By the related art, the work flow capable of processing the document image to be treated by the user is presented, and an operation burden when the user selects a desired work flow from plural work flows can be reduced.

However, in the related art, since a desired work flow is retrieved from work flows executed in the past, there is a problem that a work flow which was not executed does not become an object of retrieval.

Besides, there is a problem that even if a work flow capable of processing the document data as the processing object is included in the work flows executed in the past, unless the content of the document data processed by the work flow in the past is similar to the content of the document data as the processing object at this time, the work flow is not extracted as the retrieval result.

### SUMMARY

In order to solve the foregoing problem, according to an aspect of the invention, a work flow management apparatus for managing a work flow includes a processing object information acquisition section to acquire information relating to document data as a processing object of a work flow, a configuration information acquisition section to acquire information relating to respective processing steps constituting the work flow as a management object, a condition information acquisition section to acquire, based on the information acquired by the configuration information acquisition section, information relating to execution conditions for execution of the respective processing steps, and an execution possibility determination section to determine, based on the information acquired by the condition information acquisition section, whether the document data whose information is acquired by the processing object information acquisition section can be processed by the work flow as the management object.

Besides, according to another aspect of the invention, a work flow management apparatus includes a registration section which correlates information relating to document data as a processing object in an executed work flow with information relating to respective processing steps constituting the executed work flow and registers them in a specified database, a processing object information acquisition section to acquire information relating to document data as a processing object of a work flow, a condition information acquisition section to acquire information relating to execution conditions for execution of respective work flows registered by the registration section, and a retrieval section to retrieve, based on the information acquired by the condition information acquisition section, a work flow capable of processing the document data whose information is acquired by the processing object information acquisition section from a group of the work flows registered by the registration section.

Besides, according to another aspect of the invention, a work flow management method for managing a work flow includes acquiring information relating to document data as a processing object of a work flow, acquiring information relating to respective processing steps constituting the work flow as a management object, acquiring, based on the acquired information relating to the respective processing steps, information relating to execution conditions for execution of the respective processing steps, and determining, based on the acquired information relating to the execution conditions, whether the document data whose information is acquired can be processed by the work flow as the management object.

### DESCRIPTION OF THE DRAWINGS

FIG. 1 is a system structural view for explaining a work flow system including a work flow management apparatus according to a first embodiment.

FIG. 2 is an outer appearance perspective view of an MFP 1 according to the first embodiment.

FIG. 3 is a function block diagram of the MFP 1 according to the first embodiment.

FIG. 4 is a view showing a work flow editing screen displayed on a display of a work flow server 2.

FIG. 5 is a view for explaining an image acquisition notification work flow.

FIG. 6 is a view for explaining a process of a work flow management system according to the first embodiment.

FIG. 7 is a view showing an acquired document image Q.

FIG. 8 is a view showing the acquired document image Q.

FIG. 9 is a view showing an acquired document image N.

FIG. 10 is a function block diagram showing a structure of a work flow management system according to a second embodiment of the invention.

FIG. 11 is a flowchart showing a flow of a process in the work flow management system according to the second embodiment of the invention.

### DETAILED DESCRIPTION

Hereinafter, embodiments of the invention will be described with reference to the drawings.

### First Embodiment

First, a first embodiment of the invention will be described.

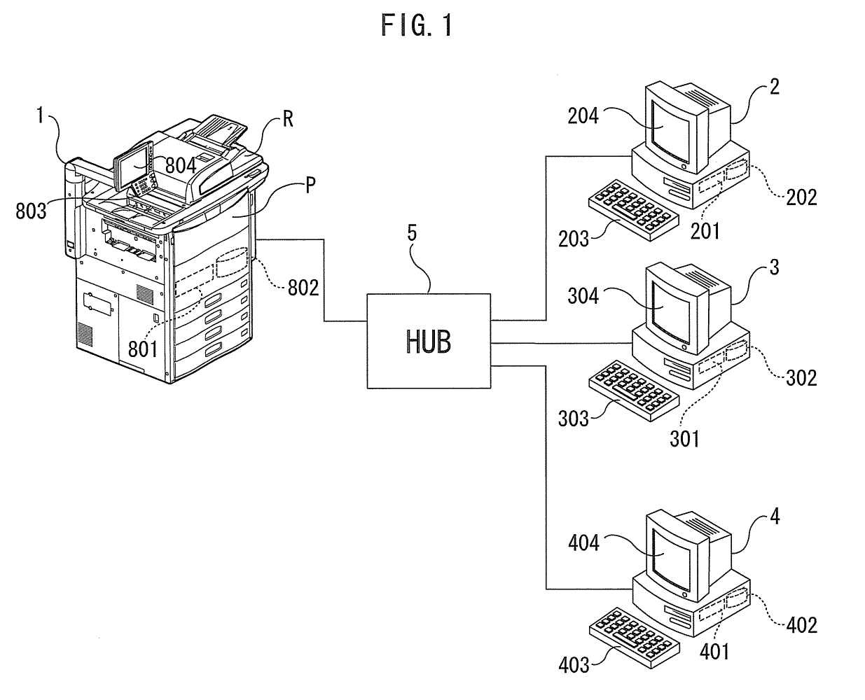

FIG. 1 is a system structural view for explaining a work flow system including a work flow management apparatus according to an embodiment of the invention.

The work flow system according to this embodiment includes an image processing apparatus (a Multi Function Peripheral (MFP)) 1 (hereinafter referred to as an MFP 1), a work flow server 2 to perform a process relating to a work flow, a file server 3 to store document images and relevant data, a client PC 4 which accesses the work flow server 2 and the file server 3 and can receive a service, and a HUB 5.

Besides, the MFP 1, the work flow server 2, the file server 3 and the client PC 4 are LAN connected through the HUB 5 so that they can communicate with each other.

The MFP 1 includes a CPU 801, a MEMORY 802, an operation input section 803 and a display section 804. The work flow server 2 includes a CPU 201, a MEMORY 202, an operation input section 203 and a display section 204. The file server 3 includes a CPU 301, a MEMORY 302, an operation input section 303 and a display section 304. The client PC 4 includes a CPU 401, a MEMORY 402, an operation input section 403 and a display section 404.

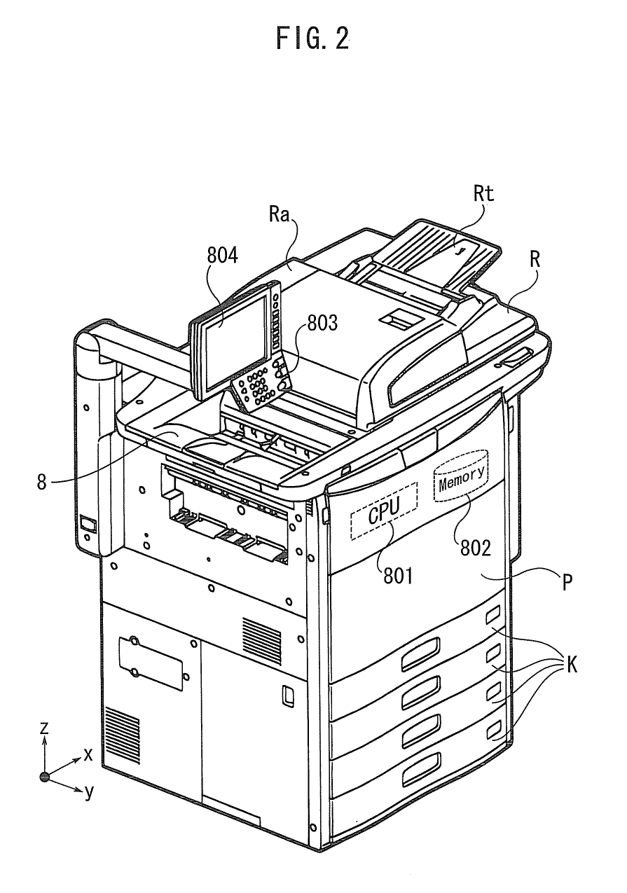

FIG. 2 is an outer appearance perspective view of the MFP 1 according to this embodiment.

The MFP 1 includes an auto document feeder Ra, an image reading section R, an image forming section P, a discharge tray 8, the CPU 801, the MEMORY 802, the operation input section 803 and the display section 804.

The auto document feeder (ADF) Ra has a function to continuously automatically feed plural documents placed on a tray Rt to a specified document read position of the image reading section R.

The image reading section R is disposed at an upper part of a main body of the MFP 1, and has a function to scan and read images of sheet documents automatically fed by the auto document feeder A, or sheet documents or book documents placed on a not-shown document placing table.

The image forming section P has a function to form a developer image on a sheet fed from a paper feed cassette K based on an image read by the image reading section R from a document or image data received by the MFP 1 from an external equipment.

The sheet on which the image is formed by the image forming section P is discharged onto the discharge tray 8.

The CPU 801 serves to execute various processes in the MFP 1, and also serves to realize various functions by executing programs stored in the MEMORY 802. The MEMORY 802 can be constructed of a RAM (Random Access Memory), a ROM (Read Only Memory), a DRAM (Dynamic Random Access Memory), an SRAM (Static Random Access Memory), a VRAM (Video RAM) or the like, and serves to store various information and programs used in the MFP 1.

The operation input section 803 includes, for example, a keyboard, a mouse, a touch panel, a touch pad, a graphics tablet or the like.

The display section 804 includes, for example, an LCD (Liquid Crystal Display), an EL (Electronic Luminescence), a PDP (Plasma Display Panel), a CRT (Cathode Ray Tube) or the like.

Besides, the functions of the operation input section 803 and the display section 804 can be realized by a so-called touch panel display. Incidentally, it is assumed that the CPU 201, the MEMORY 202, the operation input section 203 and the display section 204 provided in the work flow server 2, the CPU 301, the MEMORY 302, the operation input section 303 and the display section 304 provided in the file server 3, and the CPU 401, the MEMORY 402, the operation input section 403 and the display section 404 provided in the client PC 4 also have the same functions as the CPU 801, the MEMORY 802, the operation input section 803 and the display section 804.

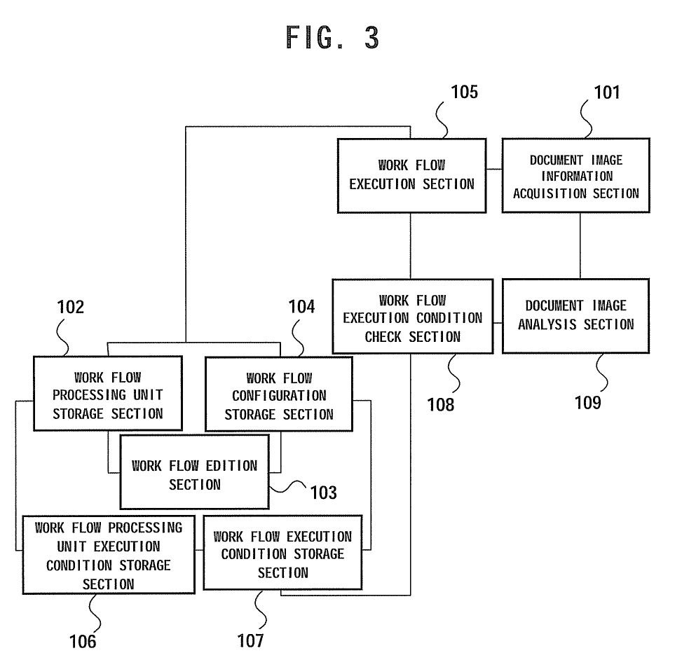

FIG. 3 is a function block diagram of the MFP 1 according to the first embodiment of the invention.

As shown in FIG. 3, the work flow management apparatus according to the first embodiment includes a document image information acquisition section 101, a work flow processing unit storage section 102, a work flow edition section 103, a work flow configuration storage section 104, a work flow execution section 105, a work flow processing unit execution condition storage section 106, a work flow execution condition storage section 107, a work flow execution condition check section 108, and a document image analysis section 109.

Hereinafter, the details of the respective functions provided in the work flow management apparatus according to this embodiment will be described.

The document image information acquisition section 101 (corresponding to a processing object information acquisition section) acquires a document image (document data) obtained by scanning a document by the image reading section R and information of a scan operator (information relating to document data as a processing object of a work flow). The document image information acquisition section 101 is provided in, for example, the MFP 1.

Specifically, the document image information acquisition section 101 acquires, as the information relating to the document data as the processing object of the work flow, at least one of (1) a layout of an object (character, figure, photographic image, illustration image, frame line, table, etc.) in a document specified by the document data, (2) identification information of the user who instructs execution of a process using the work flow on the document data as the processing object, and (3) the type of the object included in the document specified by the document data.

The work flow processing unit storage section 102 stores “work flow processing units (corresponding to respective processing steps)” as units of the work flow process, such as “text is extracted from a document image” and “document image is stored”, into, for example, the MEMORY 802 of the MFP 1 or the work flow server 2.

The work flow edition section 103 edits, based on the operation input of the user through the operation input section 803, the sequence of execution of work flow processing units stored by the work flow processing unit storage section 102 and attribute values set for the work flow processing units.

The work flow configuration storage section 104 stores, as the work flow, the execution sequence of the work flow processing units edited by the work flow edition section 103 and the attributes set for the work flow processing units into, for example, the MEMORY 802 of the MFP 1 or the work flow server 2.

The work flow execution section 105 executes the work flow stored in the work flow configuration storage section 104 in accordance with the execution sequence of the work flow processing units while the designated document image is made the object.

The work flow processing unit execution condition storage section 106 stores a condition “work flow processing unit execution conditions” required to execute the respective work flow processing units stored in the work flow processing unit storage section 102 into, for example, the MEMORY 802 of the MFP 1 or the work flow server 2.

The work flow execution condition storage section 107 stores “work flow execution conditions” as conditions required to execute the respective work flows stored in the work flow configuration storage section 104 into, for example, the MEMORY 802 of the MFP 1 or the work flow server 2.

The work flow execution condition check section 108 (corresponding to a configuration information acquisition section, a condition information acquisition section, or an execution possibility determination section) checks whether the work flow execution condition of the work flow to be executed, which is stored in the work flow execution condition storage section 107, is satisfied or not when the work flow execution section 105 executes the work flow specified for the document image acquired by the document image information acquisition section 101.

Specifically, the work flow execution condition check section 108 acquires information relating to the respective processing steps constituting the work flow as the object of the check from, for example, the MEMORY 802 of the MFP 1 or the work flow server 2. The information relating to the respective processing steps includes, for example, ID information made to correspond to the respective processing steps constituting the work flow, or ID information attached to the whole work flow configured by combining processing steps.

Besides, the work flow execution condition check section 108 acquires, based on the acquired information relating to the respective processing steps, information relating to the execution conditions for execution of the respective processing steps from the MEMORY 802 of the MFP 1 or the work flow server 2.

Next, the work flow execution condition check section 108 checks (determines), based on the information relating to the execution conditions for execution of the respective processing steps, whether the document data whose information is acquired by the document image information acquisition section 101 can be processed by the work flow as the check object.

The document image analysis section 109 executes an analysis process of information in an image, such as whether a character string image exists at a specified place in the image, with respect to the document image acquired by the document image information acquisition section 101. The work flow execution condition check section 108 uses also the analysis result in the document image analysis section 109 for the check process of the work flow when necessary.

Next, the management of the work flow in the work flow system according to this embodiment will be described in detail.

In the work flow management system according to this embodiment, a work flow created by a user can be executed while for example, a document image obtained by scanning a document by the image reading section R is made an object.

The user uses the work flow edition section 103 and can create a desired work flow by operation input to the operation input section such as a keyboard or a mouse.

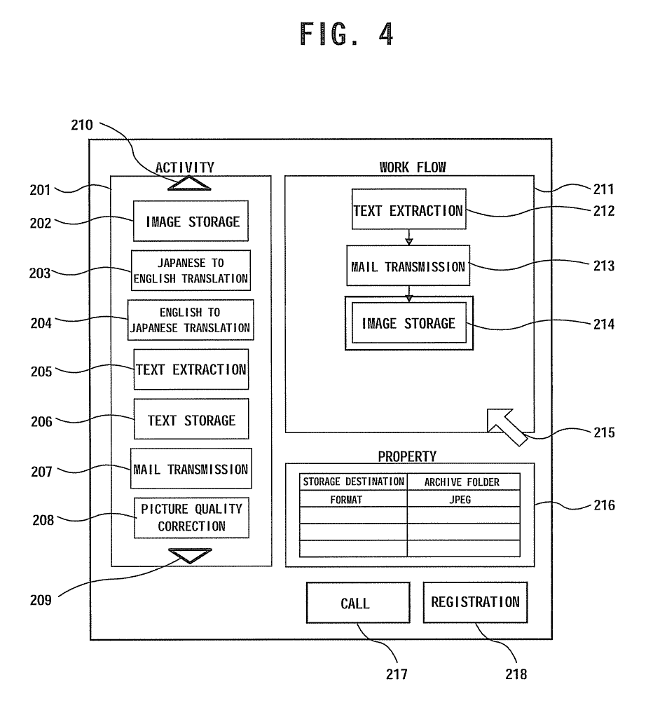

The work flow edition section 103 is provided in, for example, the work flow server 2, and can be used as a Web application in which a user interface is displayed on the display section 204 of the work flow server. The user can create or edit the work flow through the Web browser in the work flow server 2. FIG. 4 shows an example of a work flow editing screen displayed on the display section 204 of the work flow server 2.

FIG. 4 shows work flow processing units of an icon 202 to an icon 208 in an area 201 entitled “activity”. The respective “work flow processing units” displayed here are stored in the work flow processing unit storage section 102 provided in the work flow server 2, and these are listed and displayed in the area 201.

The user can operate a mouse pointer 215 by using the operation input section 203 (including a keyboard, a mouse or the like) provided in the work flow server 2. The user clicks a button 209 or a button 210 to scroll the icons of the work flow processing units displayed in the area 201, and can screen display a not-displayed icon.

The work flow created by operating the work flow edition section 103 is displayed in an area 211. Here, work flow processing units constituting the work flow are displayed as icons 212 to 214, and the work flow processing units are executed in the sequence of arrows. An icon in the area 201 is dragged by a mouse to a desired position in the area 211, so that the work flow processing unit is added to the arbitrary position in the work flow and the work flow can be edited.

In the example shown in FIG. 4, the icon 214 is surrounded by a thick line, and a state is shown in which the icon 214 indicating the “image storage” work flow processing unit is selected. The user can select a work flow processing unit by clicking an icon displayed in the area 211. When the work flow processing unit is selected as stated above, attributes of the selected work flow processing unit are displayed in an area 216 entitled “property”. Here, the attributes set for the presently selected “image storage” work flow processing unit 214 are listed and displayed, and “attribute name”, “storage destination” and “format” and values set for the respective attributes are displayed in the area 216. The user can edit a value of an attribute by clicking an arbitrary raw in the area 216, and can input a desired character string by a device such as a keyboard. Incidentally, when a work flow processing unit selected in the area 211 is desired to be deleted, it can be deleted by depressing a Delete key or the like in the operation input section 203 provided in the work flow server 2.

When the work flow is created by the process as stated above, the user can store the created work flow into the work flow configuration storage section 104 by clicking a button 218. The work flow configuration storage section 104 is provided in, for example, the work flow server 2, and stores, in a unit of a work flow, the execution sequence of the work flow processing units created by the work flow edition section 103 and the attribute values (configuration information of the work flow) set for the respective work flow processing units. When the work flow is stored, the user can give an arbitrary name such as “image acquisition notification work flow” to the work flow, and this name is also stored as the information of the work flow.

Besides, when a button 217 is clicked, a work flow group stored in the work flow configuration storage section 104 is displayed as a list of work flow names. When a work flow is selected from the displayed list, the selected work flow is displayed in the area 211, and the user can edit the selected work flow.

When the editing is ended, the user can update the registered work flow by clicking the button 218.

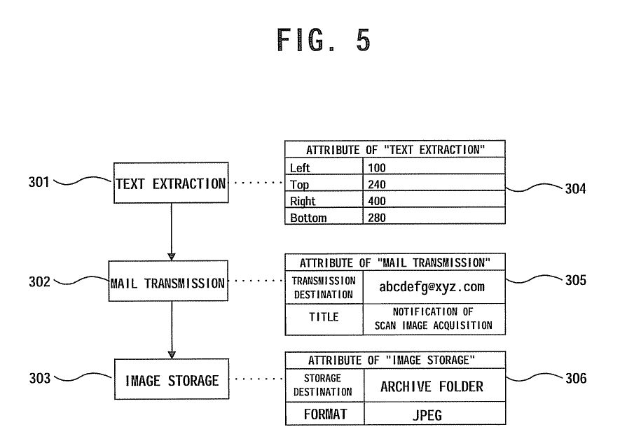

Here, as an example, it is assumed that an “image acquisition notification work flow” shown in FIG. 5 is created using the work flow edition section 103.

In the “image acquisition notification work flow”, first, a “text extraction” work flow processing unit 301 is executed. Here, an attribute 304 is set for the “text extraction” work flow processing unit 301. In the “text extraction” work flow processing unit, a character image in an area set by the attribute is read from a document image as a processing object of the work flow, and a process such as an OCR is performed to acquire text data. Here, a rectangular area set by the attribute of Left, Top, Right and Bottom is read from the document image, and text data is acquired from a character string image existing in the rectangular area.

Next, in the “image acquisition notification work flow”, a “mail transmission” work flow processing unit 302 is executed. Here, an attribute 305 is set for the “mail transmission” work flow processing unit 302. In the “mail transmission” work flow processing unit, the text data acquired in the work flow is made the main body, and the mail is transmitted while using the destination and title set in the attribute. Here, the text data acquired in the “text extraction” work flow processing unit 301 is made the main body of the mail, the title is made “notification of scan image acquisition”, and the mail is transmitted to “abcdefg@xyz.com”.

Next, in the “image acquisition notification work flow”, an “image storage” work flow processing unit 303 is executed. Here, an attribute 306 is set for the “image storage” work flow processing unit 303. In the “image storage” work flow processing unit, the acquired document image is stored as an image file into the file server 3 or the client PC 4 while using the storage destination and the format set in the attribute. Here, the document image as the work flow processing object is stored as a JPEG file into an “archive folder”.

This is the end of the “image acquisition notification work flow”.

Next, the work flow processing unit execution condition storage section 106 will be described. With respect to a work flow processing unit stored in the work flow processing unit storage section 102, a condition necessary for execution is conceivable. Then, a program (hereinafter referred to as an execution condition check program) for checking whether the condition is satisfied is stored for each work flow processing unit in the work flow processing unit execution condition storage section 106. When the document image acquired by the document image information acquisition section 101, the scan operator information, and the attribute set for the work flow processing unit by the work flow edition section 103 are inputted, the execution condition check program checks, in the inside of the program, whether the work flow processing unit can be executed, and sends back information indicating that execution is possible or impossible.

For example, the “text extraction” work flow processing unit used in the “image acquisition notification work flow” can not be executed unless a character string image exists in the area set by the attribute in the document image as the processing object of the work flow. Then, in the “text extraction” work flow processing unit, the condition of “in a document image, a character string image exists in an area specified by an attribute” is conceivable.

Thus, it is desirable to perform such a process that in the document image, it is checked whether the character image exists in the area set by the attribute, and when exists, information indicating execution is possible is sent back, and when not exist, information indicating that execution is impossible is sent back. A program to cause the CPU to perform such a process is stored as an execution condition check program of the “text extraction” work flow processing unit in the work flow processing unit execution condition storage section 106.

Besides, with respect to the “mail transmission” work flow processing unit used in the “image acquisition notification work flow”, the condition of “information relating to a document image in which characters of “FOR INTERNAL USE ONLY” are written can not be leaked to the outside of the company” is conceivable. Thus, it is desirable to perform such a process that when the characters of “FOR INTERNAL USE ONLY” are written in the document image and the transmission destination set in the attribute is an external address, information indicating that execution is impossible is sent back, and in the other case, information indicating that execution is possible is sent back. A program to cause the CPU to execute the process as stated above is stored as an execution condition check program of the “mail transmission” work flow processing unit in the work flow processing unit execution condition storage section 106.

Besides, with respect to the “image storage” work flow processing unit used in the “image acquisition notification work flow”, the condition of “when a scan operator does not have a right to access the storage destination of an image file, the image file can not be stored” is conceivable. Thus, it is desirable to perform such a process that when the user corresponding to a user ID or the like acquired by user authentication or the like in the MFP 1 has an access right to the storage destination set in the attribute, information indicating that execution is possible is sent back, and when not, information indicating that execution is impossible is sent back. A program to cause the CPU to execute the process as stated above is stored as an execution condition check program of the “image storage” work flow processing unit in the work flow processing unit execution condition storage section 106.

Here, with respect to the process of analyzing information included in the document image, such as “a character string image exists in the specified area in the document image” or “characters of “FOR INTERNAL USE ONLY” are written in the document image”, the document image analysis section 109 can be made to perform the process.

As stated above, the execution condition check programs of the respective work flow processing units stored in the work flow processing unit storage section 102 are stored in the work flow processing unit execution condition storage section 106.

Next, the work flow execution condition storage section 107 will be described. The work flow execution condition storage section 107 stores information relating to the conditions required to execute the work flows stored in the work flow configuration storage section 104.

When a work flow is newly created by the work flow edition section 103 or an existing work flow is updated and is stored in the work flow configuration storage section 104, the work flow execution condition storage section 107 determines a condition required to execute the work flow and stores it.

Specifically, a condition required to execute the work flow (determined to be executable) is such that all execution condition check programs correlated with the respective work flow processing units constituting the work flow, which are stored in the work flow processing unit execution condition storage section 106, are executed and information indicating that all the work flow processing units can be executed is sent back.

For example, the “image acquisition notification work flow” includes the three work flow processing units of “text extraction”, “mail transmission” and “image storage”.

The condition required to execute the work flow is such that all execution condition check programs correlated with the three work flow processing units are executed, and the information indicating that all the three programs can be executed is sent back. Then, when the “image acquisition notification work flow” is stored in the work flow configuration storage section 104, the names of the three execution condition check programs, which are required to check the execution condition of the work flow, are stored as the information relating to the execution condition of the “image acquisition notification work flow” into the work flow execution condition storage section 107.

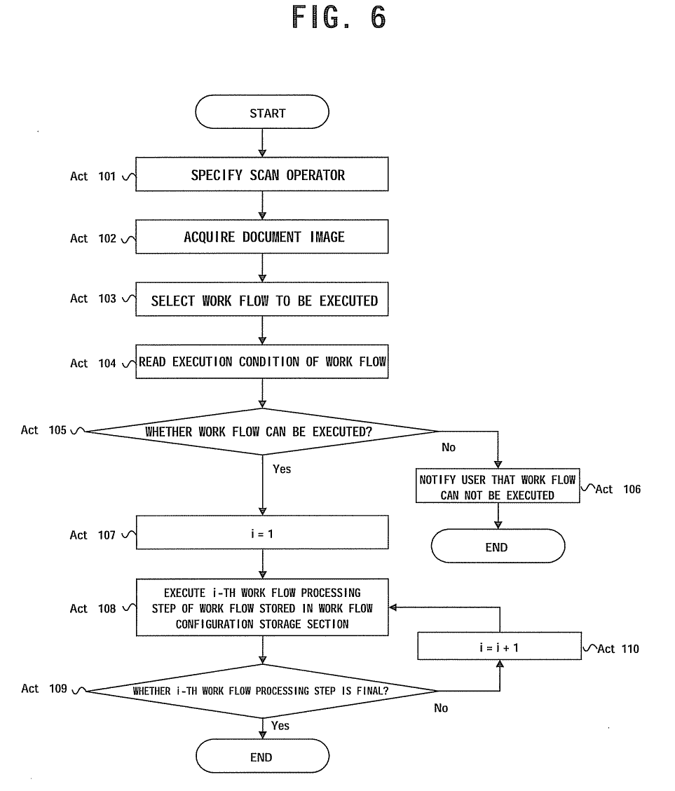

Next, a work flow process in the work flow management system according to this embodiment will be described using a flowchart 1 shown in FIG. 6.

First, at Act 101, the document image information acquisition section 101 acquires a scan operator name (or information to identify the scan operator) acquired in the MFP 1 by user authentication or the like. Specifically, as an acquisition method of information for identifying the scan operator, there is such a method that a personal authentication card including ID information to specify the user is read by a card reader provided in the MFP 1.

Next, at Act 102, the image reading section R is used to scan a document, and the document image information acquisition section 101 acquires the document image.

Next, at Act 103, the work flows stored in the work flow configuration storage section 104 are displayed as a list of work flow names on the display section 804. The user operates the operation input section 803, and selects a work flow, which is desired to be executed on the document image obtained by scanning, from the list.

Next, at Act 104, the work flow execution condition check section 108 reads the condition as to whether the work flow is executable from the work flow execution condition storage section 107. The names of the execution condition check programs of the work flow processing units constituting the work flow are stored in the work flow execution condition storage section 107, and these are read.

For example, when the “image acquisition notification work flow” is selected at Act 103, the execution condition of the work flow corresponding thereto is read from the work flow execution condition storage section 107. The “image acquisition notification work flow” includes three work flow processing units of “text extraction”, “mail transmission” and “image storage”. Since the names (information relating to the execution conditions) of the execution check programs of the respective processing units are stored in the work flow execution condition storage section 107, these are read.

Next, at Act 105, the work flow execution condition check section 108 checks whether the work flow can be executed. Since the names of the execution condition check programs of the work flow processing units are read at Act 104, the work flow execution condition check section 108 delivers the document image, the scan operator name, and the attribute values set for the respective work flow processing units to the respective execution condition check programs, and executes them sequentially. The respective execution check programs which received these information sent back information as to whether the work flow processing units can be executed or not. When information indicating that execution is possible is sent back from the respective execution condition check programs for all the work flow processing units constituting the work flow, it is determined that the work flow can be executed. The execution condition check programs of the work flow processing units constituting the work flow are sequentially executed, and when at least one execution check program sends back information indicating that execution is impossible, it is determined that the work flow can not be executed.

For example, at Act 103, when the “image information acquisition notification work flow” is selected, the names of the execution condition check programs of the three work flow processing units of “text extraction”, “mail transmission” and “image storage” are read by the work flow execution condition check section 108.

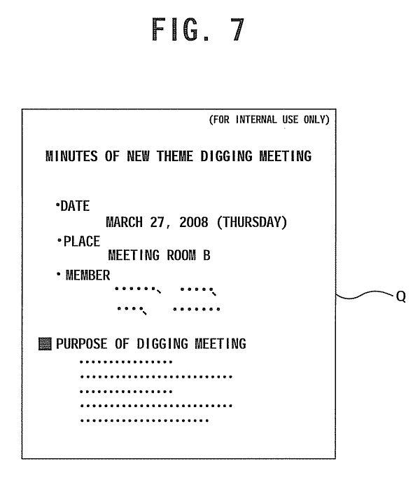

Here, it is assumed that a user A is a scanner operator at Act 101, and a document image Q as shown in FIG. 7 is acquired at Act 102.

In this case, first, the work flow execution condition check section 108 executes the execution condition check program of the “text extraction” work flow processing unit. Since the program itself is stored in the work flow processing unit execution condition storage section 106, the CPU executes this. At this time, the document image Q is delivered to the execution condition check program. The execution condition check program checks whether a character string image exists in an area set for the “text extraction” work flow processing unit.

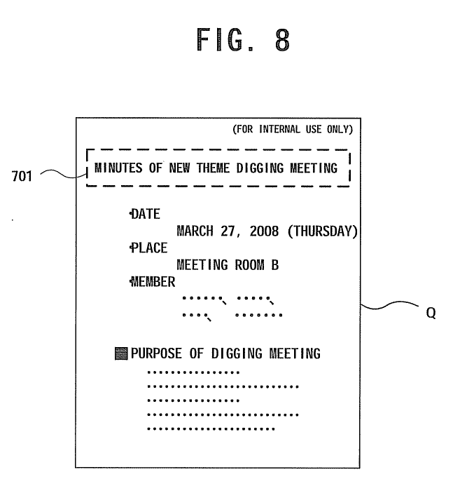

An area 701 of a dotted line frame shown in FIG. 8 is the area set by the attribute. Since a character string image exists in the portion of the document image Q, the execution condition check program sends back information indicating that the “text extraction” work flow processing unit can be executed.

That is, when a character string located at a specified position in the document is extracted in one of plural work flow processing units (processing steps) constituting the work flow as the management object, and when the character string does not exist at the specified position in the document, the work flow execution condition check section 108 (execution possibility determination section) determines that the document data can not be processed by the work flow as the management object. Here, “that the character string exists at the specified position in the document” corresponds to the “execution condition”.

Next, the work flow execution condition check section 108 executes the execution condition check program of the “mail transmission” work flow processing unit. Here, although the transmission destination in the attribute set for the “mail transmission” work flow processing unit is external, since the document image Q includes the characters of “FOR INTERNAL USE ONLY”, the execution condition check program sends back information indicating that the “mail transmission” work flow processing unit can not be executed. By this, the work flow execution condition check section 108 determines that the “image acquisition notification work flow” cannot be executed.

That is, when a process using specified information included in the document is performed in one of the plural processing steps constituting the work flow as the management object, and when the specified information is not included in the document, the work flow execution condition check section 108 (corresponding to the execution possibility determination section) determines that the document data can not be processed by the work flow as the management object. Here, “that the character string of “FOR INTERNAL USE ONLY” exists in the document” corresponds to the “execution condition”.

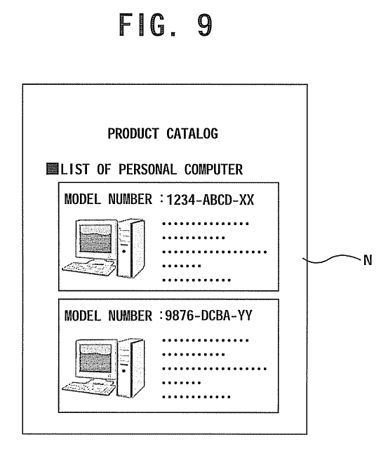

On the other hand, it is assumed that a user A is a scanner operator, and a document image N shown in FIG. 9 is acquired at Act 102.

In this case, first, the work flow execution condition check section 108 executes the execution condition check program of the “text extraction” work flow processing unit. In the document image N, since a character string image exists in an area set by the attribute of the “text extraction” work flow processing unit, information indicating that the work flow processing unit can be executed is sent back.

Next, the CPU executes the execution condition check program of the “mail transmission” work flow processing unit. Since the characters of “FOR INTERNAL USE ONLY” do not exist in the document image N, information indicating that the work flow processing unit can be executed is sent back.

Next, the execution condition check program of the “image storage” work flow processing unit is executed. Here, since the user A as the scan operator does not have an access right to the “archive folder” as the storage destination set in the attribute, the execution condition check program sends back information indicating that execution is impossible. That is, when a process requiring a specified access right is performed in one of the plural processing steps constituting the work flow as the management object, and when the user who instructs execution of the process of the work flow on the document data as the processing object does not have the specified access right, the work flow execution condition check section 108 (corresponding to the execution possibility determination section) determines that the document data can not be processed by the work flow as the management object.

Here, “that the user who instructs execution of the process of the work flow on the document data as the processing object has the specified access right” corresponds to the “execution condition”.

By this, the work flow execution condition check section 108 determines that the “image acquisition notification work flow” can not be executed.

On the other hand, when it is specified at Act 101 that the user B is the scanner operator, and the document image N is acquired similarly to the foregoing case, with respect to the execution condition check programs of the “text extraction” and the “mail transmission” work flow processing units, information indicating that execution is possible is sent back as stated above.

Besides, with respect to the execution condition check program of the “image storage” work flow processing unit, it is determined whether the user B has an access right to the “archive folder” as the storage destination set in the attribute.

Here, since the user B has the access right, the execution condition check program sends back information indicating that the “image storage” work flow processing unit can be executed. As stated above, when all the execution condition check programs send back the information indicating that the execution is possible, the work flow execution condition check section 108 determines that the “image acquisition notification work flow” can be executed on the document image N.

Besides, when a process (for example, super-resolution process, etc.) to be performed on an image object is performed in one of plural processing steps constituting the work flow as the management object, and when the image object is not included in the document as the processing object, the work flow execution condition check section 108 can determine that the document data can not be processed by the work flow as the management object. Here, “that the image object is included in the document as the processing object” corresponds to the “execution condition”.

When it is determined at Act 105 that the work flow can not be executed, Act 106 is executed. At Act 106, the message indicating that the work flow selected by the user at Act 103 can not be executed is displayed on, for example, the display section 804. Thereafter, the work flow management system ends the work flow process.

When it is determined at Act 105 that the work flow can be executed, advance is made to Act 107 and the following. At Act 107 to Act 110, the work flow execution section 105 executes the work flow selected at Act 103. The work flow execution section 105 executes the work flow in accordance with the execution sequence of the work flow processing units stored in the work flow configuration storage section 104 while applying the set attributes.

When the procedure reaches the end of the work flow and a work flow processing unit to be executed disappears, the process of the work flow execution section 105 is ended, and the work flow process by the work flow system is completed.

By adopting the structure as described in this embodiment, it is possible to previously check whether a work flow to be executed on certain document data can be actually executed. Besides, when the work flow can not be executed on the desired document data, a warning display to that effect can be given by screen display on the display section 804.

### Second Embodiment

Next, a second embodiment of the invention will be described.

A work flow management system according to this embodiment further includes an executable work flow detection section 110 in addition to the structure of the work flow system according to the first embodiment.

Specifically, the executable work flow detection section (corresponding to a retrieval section) 110 detects executable work flows from a work flow configuration storage section 104 by using a work flow execution condition check section 108 and based on image data of a document image acquired by a document image information acquisition section 101 and ID information such as a scan operator name.

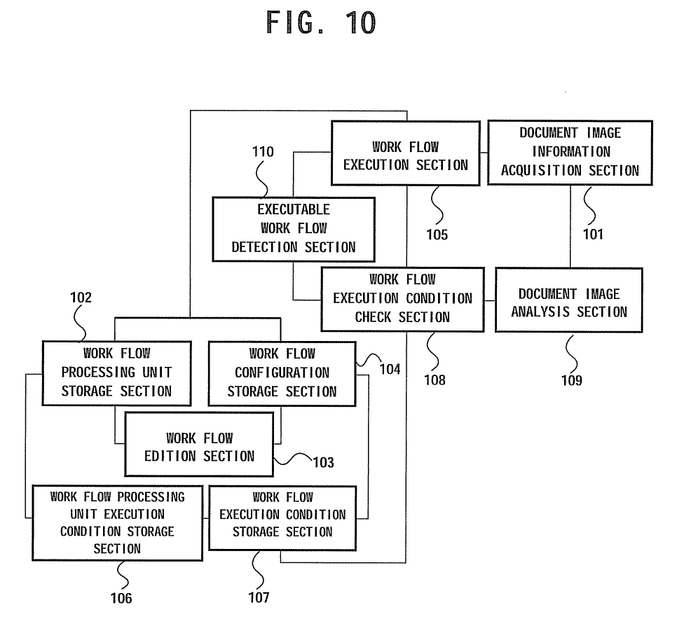

FIG. 10 is a function block diagram showing a structure of the work flow management system according to the second embodiment of the invention.

In the work flow system of this embodiment, the executable work flow detection section 110 can detect (retrieve) work flows executable for arbitrary document data from a work flow group stored in the work flow configuration storage section 104 (corresponding to a registration section).

The work flow configuration storage section 104 correlates information relating to document data as a processing object in a work flow executed in the work flow management system of this embodiment with information relating to respective processing steps constituting the executed work flow, and can register them in a work flow server 2 or the like (corresponding to a specified database).

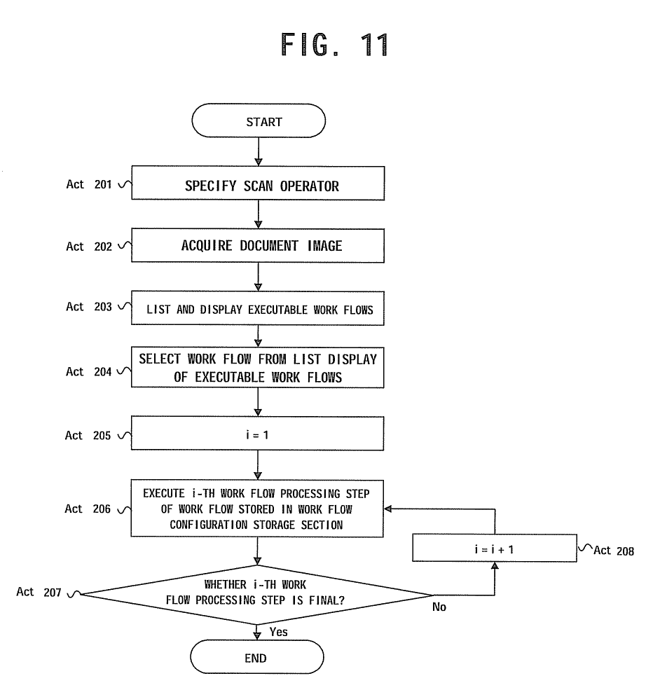

FIG. 11 is a flowchart showing a flow of a process in the work flow management system according to the second embodiment of the invention. Hereinafter, the work flow process in the work flow system according to this embodiment will be described using FIG. 11.

First, at Act 201, the document image information acquisition section 101 (corresponding to the processing object information acquisition section) acquires a scan operator name, a user ID and the like obtained by a user authentication process performed in the MFP 1. For that purpose, there is such a method that a card reader included in the MFP 1 reads a personal authentication card including ID information to specify the user.

Next, at Act 202, the document image information acquisition section 101 uses an image reading section R to read a document image from a paper document.

Next, at Act 203, the executable work flow detection section 110 retrieves work flows, which can be executed for the scan operator specified at Act 201 and the document image acquired at Act 202, from the work flow group stored in the work flow configuration storage section 104, and the work flows are listed and displayed on the display section 804.

Here, the executable work flow detection section 110 uses the work flow execution condition check section 108 and checks whether all work flows stored in the work flow configuration storage section 104 can be executed for a desired document image. At this time, work flows determined to be executable by the work flow execution condition check section 108 are displayed on the display section 804.

For example, when a user A is specified at Act 201 and a document image Q shown in FIG. 7 is acquired at Act 202, since the “mail transmission” work flow processing unit can not be executed, the “image acquisition notification work flow” is not displayed as an executable work flow.

On the other hand, when a user B is specified at Act 201 and a document image N shown in FIG. 9 is acquired at Act 202, since the “image acquisition notification work flow” is executable, it is displayed as an executable work flow on the display section 804.

As stated above, the executable work flow detection section 110 (corresponding to a second condition information acquisition section) acquires information relating to execution conditions for execution of the respective work flows, which are registered in the work flow configuration storage section 104, from the work flow execution condition storage section 107, and retrieves work flows, which can process the document data as the processing object, from the registered work flow group.

Besides, the executable work flow detection section 110 (corresponding to a processing efficiency determination section) has a function to determine the processing efficiency of document data as a processing object in each of the retrieved work flows. The “processing efficiency” here means, for example, a processing speed, the number of processing steps or the like.

By this, the executable work flow detection section 110 (corresponding to a display control section) can list and display information (for example, identification information made to correspond to a work flow, name attached to a work flow, or the like) relating to each of the retrieved work flows in such a way that when the determined processing efficiency is higher, the information is located at an upper level. Of course, only work flows in which the determined processing efficiencies are not lower than a specified threshold value can be made objects of the list display.

By this, the user can retrieve and grasp only the work flows effective for the document image as the processing object from all executable work flows.

Next, at Act 204, the user operates the operation input section 803 and selects a work flow to be executed from the list of work flows displayed as the executable work flows on the display section 804.

Next, advance is made to Act 205 and the following. At Act 205 to Act 208, the work flow execution section 105 executes the process of the work flow selected at Act 204. The work flow execution section 105 executes the process in accordance with the execution sequence of the work flow processing units stored in the work flow configuration storage section 104 while applying the set attributes.

When the procedure reaches the end of the work flow and a work flow processing unit to be executed disappears, the work flow execution section 105 ends the process, and completes the work flow process in the work flow system 2.

By adopting the structure as stated above, only the work flows executable for the scan operator and the scanned paper document are extracted from the stored work flow group and can be presented to the user.

Incidentally, in the respective embodiments described above, although the structure is exemplified in which the respective functions of the work flow management apparatus are provided in the MFP 1 or the work flow server 2, no limitation is made to this. That is, the functions of the work flow management apparatus have only to be realized in the whole work flow management system as shown in FIG. 1, and it is needless to say that the structure may be made such that the respective functions constituting the work flow management apparatus are dispersed among, for example, the MFP 1, the work flow server 2, the file server 3 and the client PC 4, or are concentrated on one equipment and are provided. Besides, also with respect to various operation inputs using the operation input section and the confirmation of information displayed on the display section, they have only to be realized in one of the MFP 1, the work flow server 2, the file server 3 and the client PC 4.

Besides, in the foregoing respective embodiments, although the case is exemplified in which the document acquired by the document image information acquisition section 101 having the function as the processing object information acquisition section is the document image obtained by scanning the document by the image reading section R, no limitation is made to this. For example, in addition to the document image scanned in the MFP 1, the document image information acquisition section 101 can acquire, for example, the image data file stored in the file server 3. Besides, the information acquired by the processing object information acquisition section may not relate to image data, but may be, for example, text data of only sentences. That is, when the document data can be the processing object in the work flow, it can be made the object of information acquisition in the processing object information acquisition section.

Besides, in the flowchart (FIG. 6) shown in the foregoing embodiment, although the example is described in which the process proceeds in the sequence of, for example, the identification of the scan operator, acquisition of the document image, selection of the work flow, and reading of the execution condition, no limitation is made to this. That is, at the timing (Act 105) when the process of determining whether the desired document data can be processed in the selected work flow is executed, information such as the identification information of the scan operator, the document image, the selection information of the work flow, and the execution condition of the work flow have only to be acquired as a result, and the sequence of acquisition of various information is arbitrary.

Besides, in the foregoing embodiment, although the example is described in which the determination as to whether certain data can be processed in each of the processing steps constituting the work flow is performed by the execution check program prepared for each step, no limitation is made to this. For example, information to specify the conditions for execution of the respective processing steps is prepared, the contents of the information to specify these conditions are compared with the information relating to the document data as the processing object, and the execution possibility of each of the processing steps may be determined.

In the work flow management technique of the related art, when work flows capable of treating the document image acquired by scan are retrieved, images similar to the document image as the object are retrieved from the work flow group processed in the past. Thus, when the images treated in the past in the work flow group executed in the past are significantly different from the image to be treated from now, there is a case where, even if a work flow capable of processing the data exists in the work flow group, it is not detected as the executable work flow.

On the other hand, according to the work flow management system of the foregoing respective embodiments, at the stage where the work flow is configured, it is possible to determine what document image can be treated by the work flow.

The respective operations of the process in the foregoing work flow management apparatus are realized by causing the CPUs of the respective equipments constituting the work flow management system to execute the work flow management programs stored in the MEMORY of the respective equipments constituting the work flow management system.

Further, the program to execute the foregoing respective operations in the computer constituting the work flow management apparatus can be provided as the work flow management program. In this embodiment, although the case is exemplified in which the program to realize the functions to carry out the invention is previously recorded in the storage area provided in the apparatus, no limitation is made to this. For example, a similar program may be downloaded from a network to the apparatus, or a computer readable recording medium storing a similar program may be installed in the apparatus. As the recording medium, its form is arbitrary as long as the program can be stored and the computer can read it. Specifically, as a recording medium, for example, an internal storage device installed in the inside of the computer, such as a ROM or a RAM, a portable storage medium such as a CD-ROM, a flexible disk, a DVD disk, an opt-magnetic disk or an IC card, a database to store computer programs or another computer and its database, a transmission medium on a line, or the like can be enumerated. Besides, the function obtained by previous installation or download may realize its function in cooperation with an OS (Operating System) of the inside of the apparatus.

Incidentally, the program in the embodiment includes a program in which an execution module is dynamically generated.

The invention can be carried out in various forms without departing from the sprit or the principle features. Thus, the foregoing embodiments are merely examples in any points and should not be interpreted as limiting the invention. The scope of the invention is interpreted by the claims, and is not restricted by the specification. Further, all modifications, various improvements, substitution and reformulation within the equivalent scope of the claims fall within the scope of the invention.

As described above in detail, according to the invention, the management technique of the work flow can be provided when a document as an arbitrary processing object is processed by the work flow.

What is claimed is:

1. A work flow management apparatus for managing a work flow, comprising:
a processing object information acquisition section to acquire information relating to document data as a processing object of a work flow;
a configuration information acquisition section to acquire information relating to respective processing steps constituting the work flow as a management object;
a condition information acquisition section to acquire, based on the information acquired by the configuration information acquisition section, information relating to execution conditions for execution of the respective processing steps; and
an execution possibility determination section to determine, based on the information acquired by the condition information acquisition section, whether the document data whose information is acquired by the processing object information acquisition section can be processed by the work flow as the management object.

2. The apparatus of claim 1, further comprising:
a registration section which correlates information relating to document data as a processing object in an executed work flow with information relating to respective processing steps constituting the executed work flow and registers them in a specified database;
a second condition information acquisition section to acquire information relating to execution conditions for execution of the respective work flows registered by the registration section; and
a retrieval section to retrieve, based on the information acquired by the second condition information acquisition section, a work flow capable of processing the document data whose information is acquired by the processing object information acquisition section from a group of the work flows registered by the registration section.

3. The apparatus of claim 2, further comprising:
a processing efficiency determination section to determine processing efficiency of the document data as the processing object in each of the work flows retrieved by the retrieval section; and
a display control section to list and display information relating to each of the work flows retrieved by the retrieval section, in which when the processing efficiency determined by the processing efficiency determination section is higher, the information is located at an upper level.

4. The apparatus of claim 1, wherein the processing object information acquisition section acquires, as the information relating to the document data as the processing object of the work flow, at least one of a layout of an object in a document specified by the document data, identification information of a user who instructs execution of the process of the work flow on the document data as the processing object, and a type of the object included in the document specified by the document data.

5. The apparatus of claim 1, wherein when a character string located at a specified position in a document is extracted in one of the plurality of processing steps constituting the work flow as the management object, and when the character string does not exist at the specified position in the document, the execution possibility determination section determines that the document data whose information is acquired by the processing object information acquisition section can not be processed by the work flow as the management object.

6. The apparatus of claim 1, wherein when a process of using specified information included in a document is performed in one of the plurality of processing steps constituting the work flow as the management object, and when the specified information is not included in the document, the execution possibility determination section determines that the document data whose information is acquired by the processing object information acquisition section can not be processed by the work flow as the management object.

7. The apparatus of claim 1, wherein when a process requiring a specified access right is performed in one of the plurality of processing steps constituting the work flow as the management object, and when a user who instructs execution of the process of the work flow on the document data as the processing object does not have the specified access right, the execution possibility determination section determines that the document data whose information is acquired by the processing object information acquisition section can not be processed by the work flow as the management object.

8. The apparatus of claim 1, wherein when a process to be applied to an image object is performed in one of the plurality of processing steps constituting the work flow as the management object, and when the image object is not included in the document as the processing object, the execution possibility determination section determines that the document data whose information is acquired by the processing object information acquisition section can not be processed by the work flow as the management object.

9. A work flow management apparatus comprising:
a registration section which correlates information relating to document data as a processing object in an executed work flow with information relating to respective processing steps constituting the executed work flow and registers them in a specified database;
a processing object information acquisition section to acquire information relating to document data as a processing object of a work flow;
a condition information acquisition section to acquire information relating to execution conditions for execution of respective work flows registered by the registration section; and
a retrieval section to retrieve, based on the information acquired by the condition information acquisition section, a work flow capable of processing the document data whose information is acquired by the processing object information acquisition section from a group of the work flows registered by the registration section.

10. The apparatus of claim 9, further comprising:
a processing efficiency determination section to determine processing efficiency of the document data as the processing object in each of the work flows retrieved by the retrieval section; and
a display control section to list and display information relating to each of the work flows retrieved by the retrieval section, in which the processing efficiency determined by the processing efficiency determination section is higher, the information is located at an upper level.

11. A work flow management method for managing a work flow, comprising:
acquiring information relating to document data as a processing object of a work flow;
acquiring information relating to respective processing steps constituting the work flow as a management object;
acquiring, based on the acquired information relating to the respective processing steps, information relating to execution conditions for execution of the respective processing steps; and
determining, based on the acquired information relating to the execution conditions, whether the document data whose information is acquired can be processed by the work flow as the management object.

12. The method of claim 11, further comprising:
correlating information relating to document data as a processing object in an executed work flow with information relating to respective processing steps constituting the executed work flow and registering them in a specified database;
acquiring information relating to execution conditions for execution of the respective registered work flows; and
retrieving, based on the acquired information relating to the execution conditions, a work flow capable of processing the document data whose information is acquired from a group of the registered work flows.

13. The method of claim 12, further comprising:
determining processing efficiency of the document data as the processing object in each of the retrieved work flows; and
listing and displaying information relating to each of the retrieved work flows, in which when the determined processing efficiency is higher, the information is located at an upper level.

14. The method of claim 11, wherein as the information relating to the document data as the processing object of the work flow, at least one of a layout of an object in a document specified by the document data, identification information of a user who instructs execution of the process of the work flow on the document data as the processing object, and a type of the object included in the document specified by the document data is acquired.

15. The method of claim 11, wherein when a character string located at a specified position in a document is extracted in one of the plurality of processing steps constituting the work flow as the management object, and when the character string does not exist at the specified position in the document, it is determined that the document data whose information is acquired can not be processed by the work flow as the management object.

16. The method of claim 11, wherein when a process of using specified information included in a document is performed in one of the plurality of processing steps constituting the work flow as the management object, and when the specified information is not included in the document, it is determined that the document data whose information is acquired can not be processed by the work flow as the management object.

17. The method of claim 11, wherein when a process requiring a specified access right is performed in one of the plurality of processing steps constituting the work flow as the management object, and when a user who instructs execution of the process of the work flow on the document data as the processing object does not have the specified access right, it is determined that the document data whose information is acquired can not be processed by the work flow as the management object.

18. The method of claim 11, wherein when a process to be applied to an image object is performed in one of the plurality of processing steps constituting the work flow as the management object, and when the image object is not included in the document as the processing object, it is determined that the document data whose information is acquired can not be processed by the work flow as the management object.
